(19) United States
(12) Patent Application Publication
(10) Pub. No.: US 2014/0143062 A1
(43) Pub. Date: May 22, 2014

(54) SYSTEM AND METHOD OF ADVERTISING USING BIOMETRICS DRIVEN REGISTRATION

(71) Applicant: Joseph M. Jones, Cary, NC (US)

(72) Inventor: Joseph M. Jones, Cary, NC (US)

(21) Appl. No.: 13/682,084

(22) Filed: Nov. 20, 2012

(51) Int. Cl. G06Q 30/02

(52) U.S. Cl. CPC G06Q 30/0269; G06Q 30/0267; G06Q 30/0601
USPC 705/14.64; 705/14.66; 705/26.1

(57) ABSTRACT

The present invention utilizes a web app on both user's mobile device and merchant's website for using biometrics to identify and deliver user information across multiple merchants and allow for targeted advertising to be delivered to the user from the merchant using the identified user's information.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a method for securely accessing a plurality of websites or apps, especially for advertising and purchases. Even further, it relates to use of biometrics with a single site or app spread across numerous merchants or sites or apps.

2. Description of Related Art

The use of biometrics for identity and for permission has been long held as a useful tool to prevent fraud and confirm identity. As the advent of computers has caused a wider problem of identity, some use of biometrics has occurred for the purpose of both identity and permission. When a user signs into a new website for purchase or use of the site, they frequently have to provide details of the person, location, and the like especially if there is a purchase.

In US patent application 2010/0042835 to Lee there is taught the use of encrypted information through an arbitrating server. The system was set up to deliver secure information to a server but only a single merchant is taught and no cross fertilization of data is suggested. The method helps prevent theft of information but does nothing to aid the difficulty in dealing with multiple site registration.

Advertising across sites is frequently done and it is not unusual to have cross advertising amongst websites, however, there is no security associated with those advertising and no general means of controlling the advertising other than waiting till a user visits a site and types in a request such as searching for an item to purchase on Amazon.

There is still a need to identify and cross coordinate security identity as well as advertising in a manner that is effective yet has some control by the user, i.e. there is some method of opting out of the process.

### BRIEF SUMMARY OF THE INVENTION

The present invention relates to a system wherein at least a one biometric sign of a user of the system is fed through a coordinating sever service and only signed up merchants can use and have access to the information of the user, but they can cross advertise products based on the association of merchants and the information gathered by the system and the information of the user.

Accordingly, in one embodiment of the present invention, there is a system for securely coordinating advertising from a plurality of internet merchants and user information of a user of at least one of the internet merchants comprising:
a) at least one biometric device producing at least one biometric information of the user for identifying the user,
b) a connection to the internet via one of the group comprising a user mobile internet device, and a user internet computer wherein the biometric information is associated with the user information;
c) a coordinating service intermediary entity associated with both the user and the plurality of merchants;
d) a coordinating service intermediary server associated with the coordinating service intermediary entity and in communication with the internet wherein the server receives the biometric information and can identify the user and send at least a portion of the user information to at least one of the plurality of merchants; and
e) an advertising coordinating entity associated with the coordinating service intermediary server which comprises a computer for receiving the advertising from the plurality of merchants and deciding which advertising to send to the user.

In another embodiment of the present invention, there is a method for providing user information over the internet to a plurality of internet merchants and providing advertising from the internet merchants to the user over the internet comprising:
a) the user accessing at least one biometric device for identifying the user;
b) the identified user providing the user information to at least one of the plurality of internet merchants over the internet;
c) at least one of the plurality of internet merchants providing advertising information to the an advertising coordinating entity;
d) an advertising coordinating entity associated with a server using a computer to decide if any advertising provided by the at least one merchant should be delivered to the user; and
e) delivering advertising to the user that advertising coordinating entity decided should be provided to the user.

In another embodiment of the present invention, there is a method for a user having user information signing up with a merchant comprising:
a) associating the user information with a user mobile internet device;
b) using one or more biometric devices to identify the user;
c) user visiting a merchant having an app for accepting user information from an identified user and accessing the app; and d) transferring the identified user information to the merchant.

### BRIEF DESCRIPTION OF THE DRAWINGS

FIG. 1 is a block diagram showing the system elements of an embodiment of the invention.

FIG. 2 is a block diagram showing the delivery of advertising to a user of the invention.

FIG. 3 is a method flow chart of the present invention.

FIG. 4 is a method flow chart for providing advertising of the present invention.

FIG. 5 is a block diagram of cross-targeted advertising.

FIG. 6 is a block diagram of a single user merchant system sign-up.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein “advertising” refers to advertising from merchants who have an internet presence. It is very desirable that advertising be directed to recipients that have some interest in the product or service being advertised. Random spam advertising is usually very unproductive and frequently leads to lowering of the good name of the advertiser. More directed advertising is good but frequently the advertising is in an unsecured type of environment. Advertising is any type of advertising the merchant selects to produce. The present invention allows an independent intermediary to coordinate the advertising with the user to more particularly match the two in the market place. Accordingly, any type of advertising is covered and in one embodiment it is digital internet based advertising.

As used herein the “merchants” are those having an internet presence and the present invention assumes there are 2 or more, or in one embodiment 10, 50, 100, 1000 or more advertisers in the present system. Most internet advertisers also allow users to register with the merchant. The present invention allows quicker sign up using the intermediary to coordinate and provide information securely and distribute internet advertising.

As used herein a “biometric device” refers to one or more devices of the type that uses/measures one or more physical characteristics of a user to determine the identity of the particular user. These types of devices are well known in the art and include, but are not limited to devices for determining fingerprints, voice recognition, retinal scanning, iris measurement, scent, vein patterns, facial recognition, bone structure, DNA, electrocardiogram, hand geometry behavioral recognition, gait, and the like. These types of devices are easily associated with a user in an online internet manner or another user's computer or cell phone based on the skill in the art. It can be connected to the internet using a use mobile device or a computer for such purposes. A mobile internet device could be a laptop, tablet, smart phone, or the like. The identified user will then be associated with the user's information.

As used herein “user information” refers to any data about the internet user that can be associated with the identified user including likes, dislikes and other information about the user. Examples include, but are not limited to, at least one of location, gender, ethnicity, age, financial information, user interests, user purchase history, credit information, user purchase search history, and family information. By associating the biometric information with the user information, the user can deliver the user information by merely confirming that the user is the authentic user that is by using the biometric device to identify the user. The user information associated with that device is delivered in total or in part to an internet merchant or as desired. When delivered to an internet merchant it can be utilized to provide sign up opt-in, consent to advertise/make purchases, or the like on the site, purchase info (including credit card information), and the like. In one embodiment, an app on the user's computer or mobile device or an app on the internet merchant can be clicked on to start the process. Then the user can initiate the user biometric device. The actual delivery is done as described further below. In one embodiment the user information can be utilized to make a purchase, for example, when the user info includes credit card information.

As used herein a “coordinating service intermediary entity” is an entity associated with both the user and the plurality of merchants over the internet. Rather than user information residing with the user where it can be hacked or easily obtained the intermediary will control the user information. For example, when the app is clicked on the intermediary would, upon confirmation of biometric identity of the user either from resident user software or software on the server, deliver all or part of the user information to the internet merchant. That way the user information is only delivered when necessary, is secure, and can easily be provided to a new merchant without retyping all the information. Likewise, the entity coordinates the advertising and coordinates delivery of advertisements to the user once selected.

As used herein the “coordinating service intermediary server” is a computer that the intermediary uses to associate with the user and merchants over the internet. It actually receives the biometric information and can authenticate it. The server can be a single server or be a multiplicity of computers associated together. The server can deliver the desired user information to the desired merchant or other website as desired. Normally, the intermediary would require both the user and merchants to register with the intermediary so that only registered users/merchants can participate and the intermediary can further control the security of the exchange of information. The advertising from the merchant can also go through the server as well as for determining which user will receive the advertising. In one embodiment, the user's internet device, i.e. the user's mobile internet device, user computer, or the like acts as the server for purposes of authentication or for deciding if advertising will be delivered or where it will be delivered. The authentication can be done by downloading software from the coordinating service on the internet. Other embodiments can be the user's device and on a separate server associated with the advertising coordinating entity or the internet such as a website or the like.

An “advertising coordinating entity” on a computer (either the server or a computer associated with the server) can determine which of the advertising of the merchants will be delivered to which of the users of the present invention. Any type of information can be utilized to make that determination matching one or more of the pieces of user information with qualities, likes and other attributes of the user information to determine what advertisement user should receive, if any. The system can also have an opt out function to allow the user to opt out of all or certain types of advertising or certain merchant's advertising making opt out a much easier effort as only one place needs to be gone to in order to make such changes.

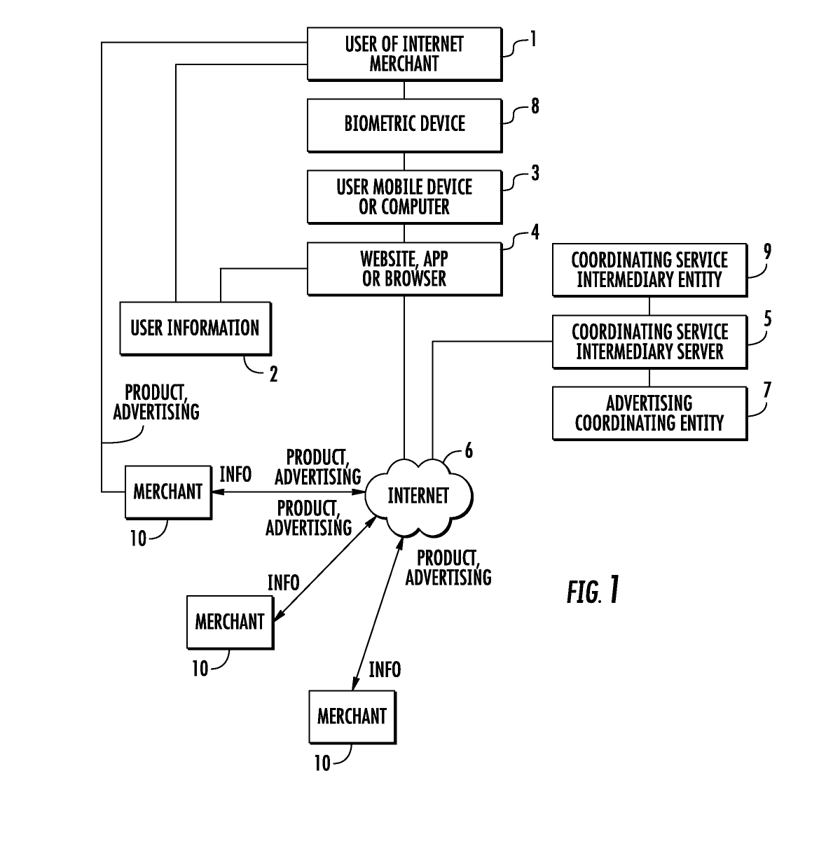

Now referring to the drawings, FIG. 1 is a block diagram of the system of the present invention. A user of internet merchant services 1 provides user information 2 and delivers it to a user's mobile device or computer 3 for delivery to a website, app or browser 4 for delivery to the associated coordinating service intermediary server 5 via internet 6. Once at the server 5 it can be stored on the server, the advertising coordinating entity 7, or both. The user 1 can also associate the user information 2 with biometric device 8 and the information about user 1 that is generated and also delivered to server 5. The coordinating service intermediary (CSI) entity 9 is the group or entity providing the intermediary service between the user 1 and plurality of merchants 10. The merchants 10 receive user 1 information and deliver products, advertising and the like either through the internet 6 or directly (UPS, mail etc).

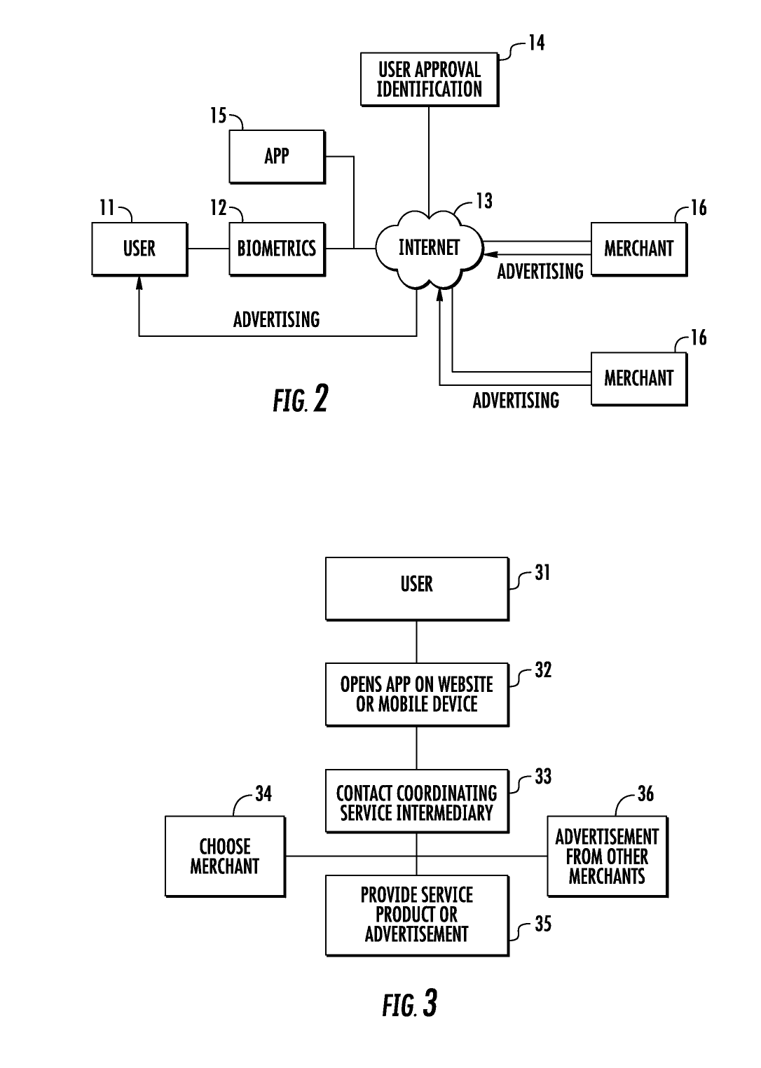

FIG. 2 is a block diagram of user 11 using biometrics 12 over internet 13 to deliver user's 11 identity to the user approval identification entity 14. An app 15 on user's mobile device, computer website, or the like can be used as a quick connect implementation. The merchants 16 can deliver advertising which can be delivered or not to the user 11.

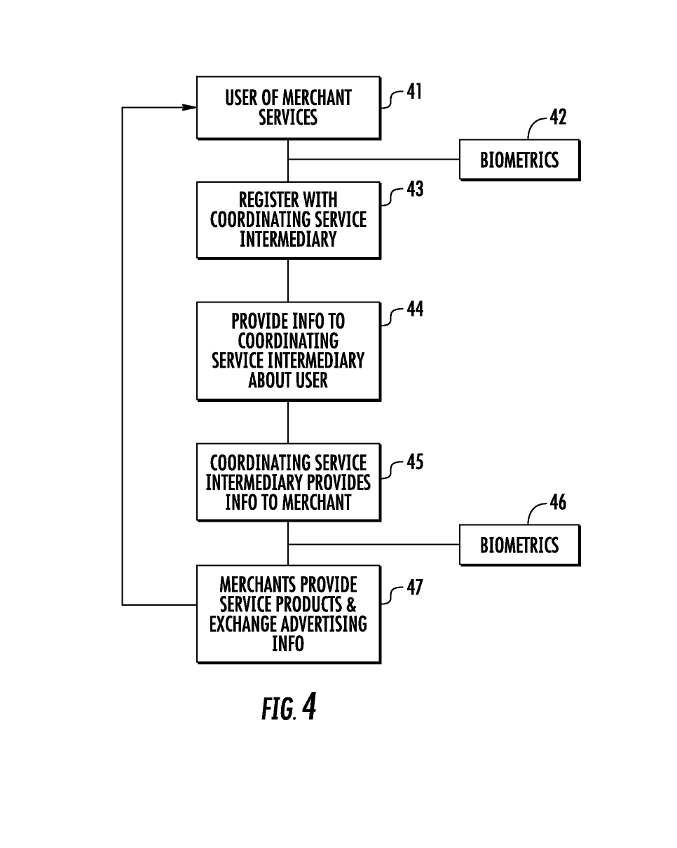

In FIG. 3 user 31 opens up an app on a website, the user's mobile device, or computer 32. This in turn connects associated CSI server 33 (through an internet). A merchant 34 is chosen and the merchant 34 can provide advertisement, product or the like 35 and other merchants 36 can also provide advertisements along the process or at the end.

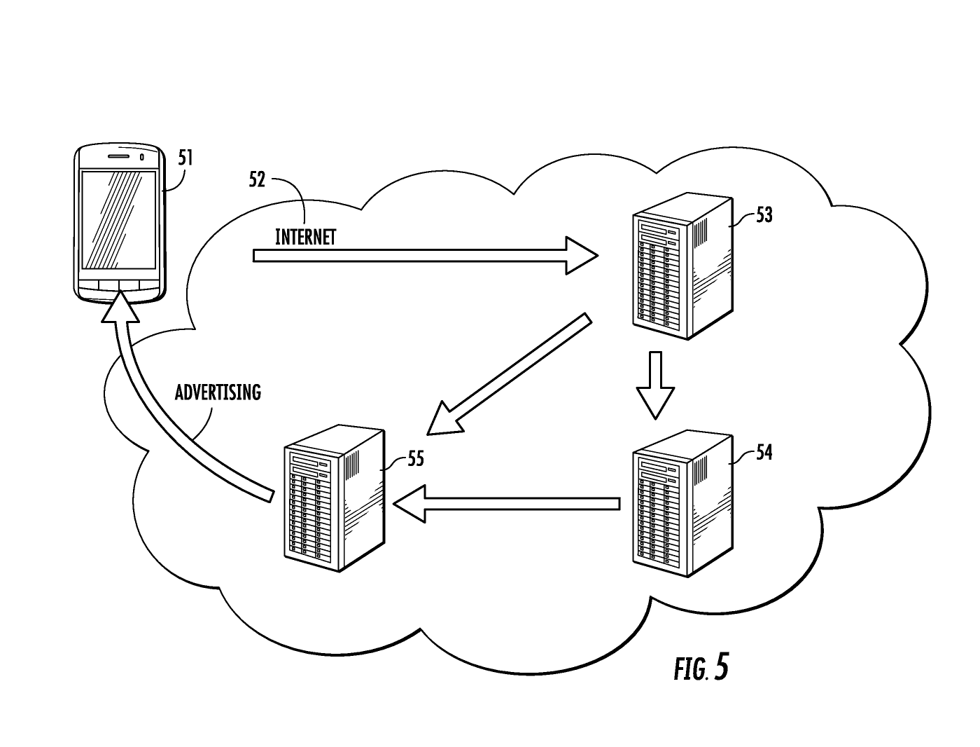

FIG. 4 depicts an embodiment of the method of the present invention. The user of merchant services 41 uses biometrics 42 and registers with a CSI 43. Then user information is provided to the CSI 44 and associated with the biometrics information. The CSI then provides user information to the merchant 45. Further access to the merchant is provided by new biometrics of user 46 wherein the merchant can provide service or products, exchange advertising and information 47, and deliver back to the user 41.

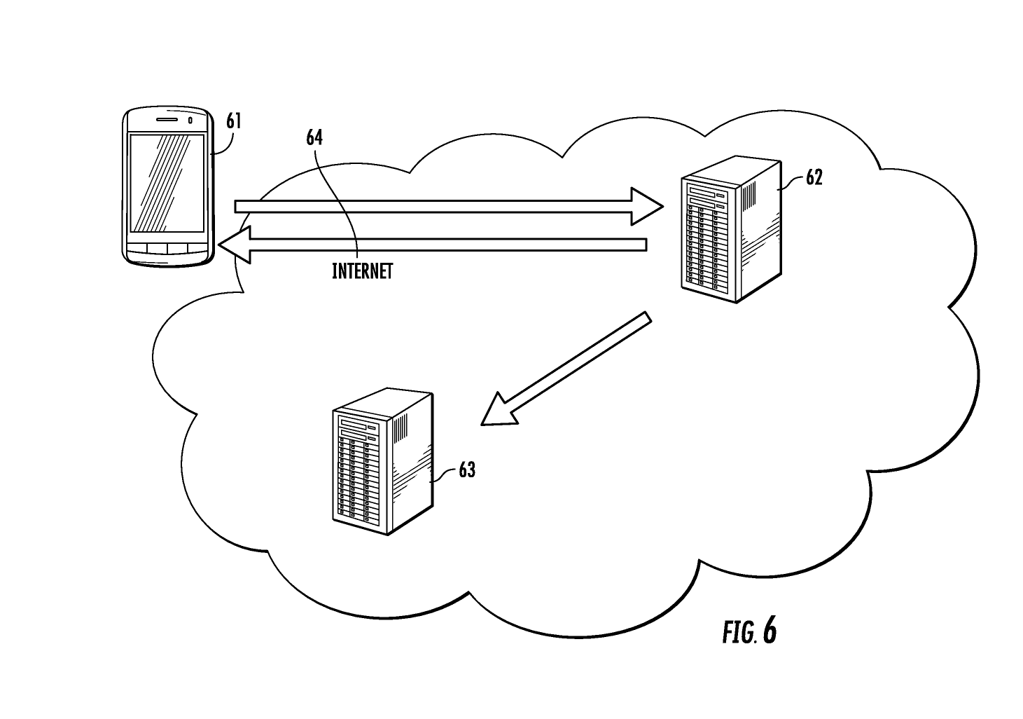

FIG. 5 is a block diagram of cross targeted advertising. A user's mobile device 51 connected to the internet 52 accesses an authentication server 53 which communicates with a merchant server 54 and advertising server 55 delivering advertising to the mobile device 51.

FIG. 6 is a block diagram of a single user sign-up with a merchant. User's mobile internet device 61 is a connected to the internet 64 to connect with application server 62 which delivers user information to a merchant server 63 after the user is authenticated.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A system for securely coordinating advertising from a plurality of internet merchants and user information of a user of at least one of the internet merchants comprising:
a) at least one biometric device producing at least one biometric information of the user for identifying the user,
b) a connection to the internet via one of the group comprising a user mobile internet device, and a user internet computer wherein the biometric information is associated with the user information;
c) a coordinating service intermediary entity associated with both the user and the plurality of merchants;
d) a coordinating service intermediary server associated with the coordinating service intermediary entity and in communication with the internet wherein the server receives the biometric information and can identify the user and send at least a portion of the user information to at least one of the plurality of merchants; and
e) an advertising coordinating entity associated with the coordinating service intermediary server which comprises a computer for receiving the advertising from the plurality of merchants and deciding which advertising to send to the user.

2. The system according to claim 1 wherein the user can access the server by clicking on an app that is on at least one of the user's computer, the user's mobile device, and a website of the plurality of merchants.

3. The system according to claim 1 wherein the biometric information is selected from at least one of fingerprints, voice recognition, retinal scanning, iris measurement, scent, vein patterns, facial recognition, bone structure, DNA, electrocardiogram, hand geometry behavioral recognition, and gait.

4. The system according to claim 1 wherein the user information is selected from at least one of location, gender, ethnicity, age, financial information, user interests, user purchase history, credit information, user purchase search history, and family information.

5. The system according to claim 4 wherein the user information is utilized by the advertising coordinating entity to determine which merchant advertisements to deliver to the user.

6. The system according to claim 1 wherein the user information allows the user to make a purchase with at least one of the plurality of merchants.

7. The system according to claim 1 wherein the server and the advertising coordinating entity computer are the same computer.

8. The system according to claim 1 wherein the advertisement is sent to the user by at least one of the internet merchant, the CSI, and the Advertising Coordinator Entity.

9. A method for providing user information over the internet to a plurality of internet merchants and providing advertising from the internet merchants to the user over the internet comprising:
a) the user accessing at least one biometric device for identifying the user;
b) the identified user providing the user information to at least one of the plurality of internet merchants over the internet;
c) at least one of the plurality of internet merchants providing advertising information to the an advertising coordinating entity;
d) an advertising coordinating entity associated with a server using a computer to decide if any advertising provided by the at least one merchant should be delivered to the user; and
e) delivering advertising to the user that advertising coordinating entity decided should be provided to the user.

10. The method according to claim 9 wherein the biometric information is selected from at least one of fingerprints, voice recognition, retinal scanning, iris measurement, scent, vein patterns, facial recognition, bone structure, DNA, electrocardiogram, hand geometry behavioral recognition, and gait.

11. The method according to claim 9 wherein the advertising coordinating entity computer is deciding based on user information.

12. The method according to claim 11 wherein the user information is selected from at least one of location, gender, ethnicity, age, financial information, user interests, user purchase history, credit information, user purchase search history, and family information.

13. The method according to claim 11 wherein the user information is utilized by the advertising coordinating entity to determine which merchant advertisements to deliver to the user.

14. The method according to claim 9 wherein the user information and biometric information is delivered to an internet merchant by first clicking on an app symbol on the user's mobile device, the user's computer, or an app on an internet merchants web site.

15. The method according to claim 9 wherein the user information allows the user to make a purchase with at least one of the plurality of merchants.

16. The method according to claim 9 wherein the server and the advertising coordinating entity computer are the same computer.

17. The method according to claim 9 wherein the advertisement is sent to the user by at least one the internet merchant, the CSI, and the Advertising Coordinator Entity.

18. A method for a user having user information signing up with a merchant comprising:
a. associating the user information with a user mobile internet device;
b. using one or more biometric devices to identify the user;
c. user visiting a merchant having an app for accepting user information from an identified user and accessing the app; and
d. transferring the identified user information to the merchant.
